(19) United States
(12) Patent Application Publication
(10) Pub. No.: US 2025/0362185 A1
(43) Pub. Date: Nov. 27, 2025

(54) Method for determining temperature in the environment of a passive superconducting component

(71) Applicant: COMMISSARIAT À L'ENERGIE ATOMIQUE ET AUX ENERGIES ALTERNATIVES, PARIS (FR)

(72) Inventors: Corentin BEILVERT, GRENOBLE (FR); Jean-Philippe MICHEL, GRENOBLE (FR)

(21) Appl. No.: 19/216,397

(22) Filed: May 22, 2025

(30) Foreign Application Priority Data
May 27, 2024 (FR) 2405414

(51) Int. Cl. G01K 7/36

(52) U.S. Cl. CPC G01K 7/36

(57) ABSTRACT

A method for determining temperature in the environment of an assembly includes at least one passive component, the passive component being integrated into a monolayer or multilayer assembly, including the following steps: determining the geometric inductance of the passive component, based on the dimensions of the passive component; measuring the inductance of the passive component, referred to as total inductance, the passive component being used in a temperature range such that it is in a superconducting state; determining the kinetic inductance of the passive component, based on the total inductance and the geometric inductance; determining the temperature based on the kinetic inductance of the component.

### CROSS-REFERENCE TO RELATED APPLICATION

This application claims priority to foreign French patent application No. FR 2405414, filed on May 27, 2024, the disclosure of which is incorporated by reference in its entirety.

### FIELD OF THE INVENTION

The invention relates to the technical field of temperature measurement, and is applied when measuring temperature in platforms comprising qubit arrays, and their control electronics. The invention also relates to a method for controlling temperature in a cryostat, and to a system for determining temperature in the environment of an assembly comprising at least one passive component.

### BACKGROUND

Quantum computing based on qubits operating at low temperatures is used for the development of quantum computers. Quantum dots, or quantum chips, are used to trap individual charges and associated spins, which are then used as qubits.

The correct functioning of these quantum chips relies on multiple technological aspects, such as wiring and packaging. The complexity of the packaging of quantum chips lies essentially in the large number of input and output signals to be addressed and read, all inside a cryostat, at temperatures of between a few mK and around 1 K.

This has led to the development of CMOS (complementary metal-oxide-semiconductor) control cryoelectronics integrated close to the qubits in the cryostat. This has also led to the development and fabrication of multi-chip assemblies in three-dimensional architectures, with a view to integrating both quantum chips and cryo-CMOS chips.

FIG. 1 illustrates one example of such a three-dimensional architecture for integrating both the quantum chip 1 and the control chip 2 (cryo-CMOS chip), used to control and read the signals transmitted by the quantum chip 1. In a general three-dimensional architecture, a structure called an “interposer” 3, for example based on silicon, has a dual function of providing mechanical support for the quantum chip 1 and the control chips 2 and of providing routing in order to connect the quantum chip 1 and the control chip 2.

The quantum chip 1 and the control chip 2 are mounted on the interposer 3 with flip-chip technology. The control chips 2, which are connected to the quantum chip 1 via routing lines of the interposer 3, perform control functions such as multiplexing signals and reading signals. Passive components 4, such as resistors, inductors and capacitors, are also integrated into the routing levels of the interposer in order to provide alternative reading capabilities. The interposer 3 is itself deposited on a substrate 5 or on a PCB. A person skilled in the art may refer to document [1], which describes the platform illustrated by FIG. 1 in more detail.

The passive components integrated with the routing tracks of the interposer 3, or into the last levels of the chips (or BEOL for back-end of line; they constitute the last routing levels of the chip) are produced with superconducting materials, the main property of which is that of making the material completely and suddenly electrically conductive below what is referred to as a critical temperature.

The use of integrated passive components made of superconducting materials thus makes it possible:
to increase the performance of passive components (quality factor);
to eliminate the Joule effect;
to limit thermal transport between the control chip 2 and the quantum chip 1.

The use conditions of the system (the three-dimensional architecture) may vary from a few mK to 10 K, in order to work below the critical temperature. Available space is highly limited, since the system is placed in a cryostat whose cooling power is limited by the volume to be cooled.

One of the problems encountered at present is thus that of measuring temperature as close as possible to the chips and/or the interposer, in order to adjust the temperature of the cryostat if necessary.

Indeed, at these temperature scales, it becomes difficult to determine whether the temperature given by the thermometer is the same as that of the sample (the subject of the measurement): the measurement may produce heat and thermalization between the thermometer and the sample is not perfect. The result is therefore a false temperature reading, the deviation of which may be difficult to characterize.

Superconductive temperature fixed point devices provide a certain number of calibrated reference temperatures between 10 mK and 7.2 K, through a resistive measurement of the superconducting transition. These devices have a temperature resolution that remains limited, and it is necessary to add a bulky apparatus that is not able to be integrated directly onto the sample undergoing the temperature measurement.

There is therefore a need to provide a method for determining temperature that is able to be integrated easily into an integrated circuit, with a stable measurement.

### SUMMARY OF THE INVENTION

One subject of the invention is therefore a method for determining temperature in the environment of an assembly comprising at least one passive component, the passive component being integrated into a monolayer or multilayer assembly, comprising the following steps:
determining the geometric inductance of the passive component, based on the dimensions of the passive component;
measuring the inductance of the passive component, referred to as total inductance, the passive component being used in a temperature range such that it is in a superconducting state;
determining the kinetic inductance of the passive component, based on the total inductance and the geometric inductance;
determining the temperature based on the kinetic inductance of the component.

Advantageously, the total inductance is measured by measuring S parameters on at least one of the ports of the passive component.

Advantageously, the total inductance is measured by measuring impedance at the terminals of the passive component.

Advantageously, the passive component comprises a type-I superconducting material selected from a group comprising Al, granular AlCu, TiN, In, W, or a type-II superconducting material selected from a group comprising Nb, NbN, NbTi, NbTiN, Nb3Sn.

Advantageously, the passive component is a transmission line, the transmission line being integrated onto one metallization level.

Advantageously, the passive component is a coil, the coil being integrated onto at least two metallization levels.

Advantageously, the passive component is integrated into the same substrate as a quantum chip or a control chip for controlling the quantum chip, so as to determine the temperature of the chip.

Advantageously, the assembly comprises a plurality of passive components, the passive components being made of different materials, the materials being determined depending on the temperature range to be determined.

Advantageously, the assembly comprises a plurality of passive components, the passive components having different dimensions, the dimensions being determined depending on the temperature range to be determined and on the targeted sensitivity.

Advantageously, the temperature range lies between what is referred to as a sensitivity temperature and the critical temperature of the material, the critical temperature corresponding to the temperature below which the material is in a superconducting state, the sensitivity temperature being lower than the critical temperature.

Advantageously, Tₛ=αT_{c}, T_{c} corresponding to the critical temperature, Tₛ corresponding to the sensitivity temperature, and 0.5≤α≤0.8.

The invention also relates to a method for controlling temperature in a cryostat, comprising:
determining a setpoint temperature of the cryostat;
measuring the temperature in accordance with the above method;
regulating the temperature if the measured temperature is different from the setpoint temperature.

The invention also relates to a system for determining temperature in the environment of an assembly comprising at least one passive component, the passive component being integrated into a monolayer or multilayer assembly, the system comprising:
a computing unit, configured to determine the geometric inductance of the passive component, based on the dimensions of the passive component;
a system for measuring the inductance of the passive component, referred to as total inductance, the passive component being used in a temperature range such that it is in a superconducting state;
the computing unit furthermore being configured to
   determine the kinetic inductance of the passive component, based on the total inductance and the geometric inductance;
   determine the temperature based on the kinetic inductance of the component.

The invention also relates to a cryostat comprising an above system.

### BRIEF DESCRIPTION OF THE DRAWINGS

Other features, details and advantages of the invention will become apparent on reading the description provided with reference to the appended drawings, which are given by way of example.

FIG. 1, already described, illustrates the mounting of chips on an interposer.

FIG. 2 illustrates one embodiment of integrating a passive component into a monolayer assembly.

FIG. 3 illustrates one example of curves of kinetic inductance as a function of temperature.

FIG. 4 illustrates embodiments of integrating a passive component into a monolayer assembly.

FIG. 5 illustrates the steps of integrating the passive component with a single metallization layer.

FIG. 6 illustrates the steps of integrating the passive component with two metallization layers.

FIGS. 7 and 8 illustrate measurements obtained with the method according to the invention.

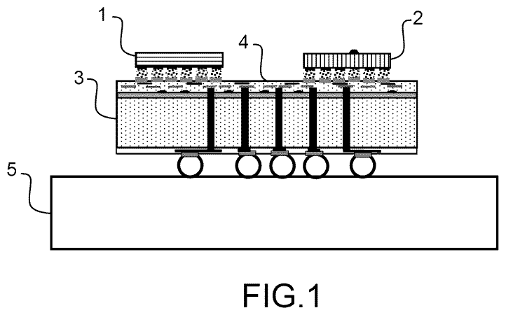

### DETAILED DESCRIPTION

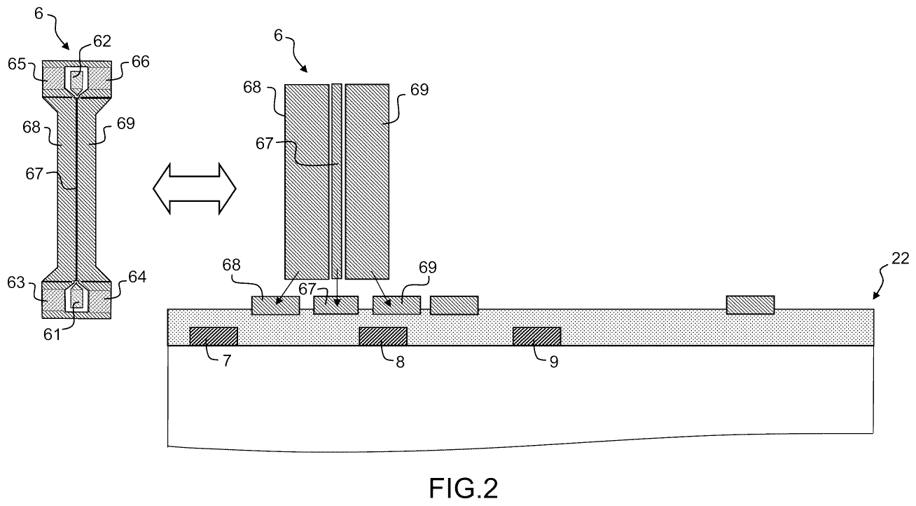

The passive component 6 illustrated by FIG. 2 is shown both in a schematic form seen from above (to the right of the double-headed arrow) and in a more detailed form (to the left of the double-headed arrow). The passive component 6 here is a transmission line, comprising a first signal pad 61, a second signal pad 62, four ground pads (63-66), a signal track 67 connecting the two signal pads, and two ground tracks (68-69) surrounding the signal track 67. Only the signal track 67 and the two ground tracks (68-69) are shown to the right of the double-headed arrow.

FIG. 2 also comprises one example of integrating the passive component 6 (represented by the signal track 67 and by the two ground tracks 68-69) into a monolayer or multilayer assembly 22. The passive component 6 is located in the environment of the quantum circuit 7, and/or of the control circuit 8, and/or of other integrated elements 9. The environment of the passive component 6 consists of elements sharing the same substrate, or else those electrically connected to the passive component.

The idea on which the invention is based is that of using the superconducting properties of the passive component, in particular of using kinetic inductance, to ascertain the temperature information.

### First Step

To this end, the method according to the invention comprises a first step of determining the geometric inductance of the passive component, based on the dimensions of the passive component.

Let Lₜₒₜₐₗ be the total inductance of the passive component, Lₖᵢₙ be its kinetic inductance, and L_{geom} be its geometric inductance.

The geometric inductance L_{geom} results from the geometry of the passive component; it is generated by the induced field of the component.

Since superconducting components have zero (or virtually zero) resistivity below their critical temperature, electrons pass very quickly through the metal lattice of the component, without any collision. Due to their speed, the electrons acquire a certain inertia, which means that a change in speed may take some time; kinetic inductance corresponds to this difficulty in terms of changing speed for the electrons.

Total inductance may be measured using one of the methods described below. Geometric inductance may be determined in advance, and does not vary from one measurement to another or as a function of external parameters such as temperature. It is thus not necessary to compute geometric inductance with each new temperature measurement, thereby making it possible to reduce the time needed to carry out the method. The computing may be done by a computing unit, or manually.

For a planar coil (for example round spiral, square, etc.), geometric inductance L_{geom} may be determined using the following formula:

$${L}_{geom} = \frac{µ {N}^{2} {d}_{avg} {c}_{1}}{2} ( ln ( \frac{{c}_{2}}{ρ} ) + {c}_{3} ρ + {c}_{4} {ρ}^{2}$$

μ corresponds to the permeability of vacuum.
N corresponds to the turns number
d_{avg} corresponds to the average diameter ((dᵢₙₜ+dₒᵤₜ)/2)
ρ corresponds to the fill level

$$ρ = \frac{( {d}_{out} - {d}_{int} )}{( {d}_{out} + {d}_{int} )}$$

c₁, c₂, c₃, and c₄ are coefficients that depend on the shape of the planar coil. A person skilled in the art may refer to Table II of document [2], which indicates these coefficients as a function of the shape of the coil.

For a transmission line, geometric inductance L_{geom} may be determined using the following formula:

$${L}_{geom} = \frac{{μ}_{0}}{4} \frac{K ( {k}^{′} )}{K ( k )}$$

K corresponds to the elliptic integral of the first kind.

$$k = \frac{W}{W + 2 S}$$

μ₀ corresponds to the permeability of vacuum.
W corresponds to the width of the line, and S corresponds to the spacing between the line and the ground plane.

$${k}^{′} = \sqrt{1 - {k}^{2}}$$

The geometric inductances of the transmission lines and of the coils may also be determined using formulas known to a person skilled in the art.

For other types of passive components, the geometric inductance L_{geom} may be determined using formulas known to a person skilled in the art.

### Second Step

The second step of the temperature measuring method is that of measuring the total inductance of the passive component. The measurement may be carried out periodically or non-periodically, for example depending on the use context of the quantum chip or of the control chip.

According to a first embodiment, the total inductance is measured by measuring S parameters on at least one of the ports of the passive component.

The S parameters may be measured using a vector network analyzer (VNA). The vector network analyzer may be external to the monolayer or multilayer assembly, or else may be integrated into it, thereby making it possible to reduce the overall footprint of the structure.

Using a single port of the vector network analyzer, only the parameter S₁₁ is able to be measured. This corresponds to the ratio between the port output voltage and the port input voltage, also known as return loss. Admittance Y₁₁ may be deduced from S₁₁ using formulas known to a person skilled in the art and described notably in [3].

By using two ports, for example the two signal pads of the transmission line, the input current and voltage and the output current and voltage are measured so as to determine admittance Y.

In particular, admittance Y is related to total inductance Lₜₒₜₐₗ by the following formula:

$${L}_{total} = \frac{1}{ω} Im ( \frac{1}{Y} )$$

ω=2πf, and f corresponds to the frequency of the signal generated at the input of one of the two ports. The frequency may be between 1 MHz and 50 GHz. During the admittance measurement, the passive component is in a superconducting state.

According to a second embodiment, the total inductance Lₜₒₜₐₗ may be measured by measuring impedance at the terminals of the passive component. Impedance may be measured with an impedance meter. The relationship linking measured impedance to total inductance Lₜₒₜₐₗ is as follows:

$${Z}_{0} = {R}_{0} + j {L}_{total} ω$$

The total inductance Lₜₒₜₐₗ is determined from the imaginary part of the impedance.

According to a third embodiment, the total inductance is measured by measuring the resonant frequency, using the natural resonance of the passive component.

If the natural resonance of the passive component is too high with respect to the frequency band in which the measurement is performed, it may be necessary to add a capacitor, connected in parallel or in series with the passive component. In the case of a parallel connection, a maximum voltage occurs at resonance (maximum impedance at resonance). In series, it is a maximum current that occurs at resonance (a minimum impedance).

Once the resonant frequency f₀ has been determined, the total inductance is determined using the following relationship:

$${L}_{total} = \frac{c}{{f}_{0}^{2}}$$

C corresponds to the capacitance of the capacitor, or to the parasitic/intrinsic capacitance of the passive component, and w₀=2πf₀.

### Third Step

The method comprises a third step of determining the kinetic inductance Lₖᵢₙ of the passive component, based on the total inductance Lₜₒₜₐₗ and on the geometric inductance L_{geom}, using the following formula:

$${L}_{kin} = {L}_{total} - {L}_{geom}$$

It will be recalled that the geometric inductance L_{geom} is obtained from the dimensions of the passive component (without having to perform the computations with each temperature measurement), and that the total inductance Lₜₒₜₐₗ is measured in accordance with the above embodiments.

### Fourth Step

In a fourth step, the temperature of the component is determined based on its kinetic inductance.

The following formula relates the temperature of the component to kinetic inductance (cf. document [4]):

$${L}_{k i n} = \frac{{R}_{□ ( {T}_{c} + 1 )} ℏ}{π Δ ( T ) tanh ( \frac{Δ ( T )}{2 {k}_{b} T} )} \frac{l}{w}$$

$$With Δ ( T ) = {Δ}_{0} \sqrt{cos ( \frac{π}{2} {( \frac{T}{{T}_{c}} )}^{2} )}$$

$$and {Δ}_{0} = 1.764 {k}_{b} {T}_{c}$$

R_{□(T}_{_{c}}₊₁₎ corresponds to sheet resistance 1 degree above critical temperature T_{c}.
ℏ corresponds to the reduced Planck constant.
Δ(T) corresponds to the superconducting energy gap, that is to say is the minimum energy that must be supplied to the superconductor to break one of its Cooper pairs.

The sheet resistance 1 degree above critical temperature T_{c} and the superconducting energy gap are characteristics of the constituent material of the passive component. These characteristics are easily measured on the directly integrated passive component, for example by measuring resistance at various temperatures.
k_{b} corresponds to the Boltzmann constant.
l and w correspond respectively to the length and width of the track (that is to say of the transmission line).

Document [5] describes another formula that relates the temperature of the component to kinetic inductance:

$${L}_{kin} = {μ}_{0} λcoth ( \frac{d}{λ} ) \frac{l}{w}$$

$$With λ ( ω , T ) = \frac{1}{\sqrt{{μ}_{0} ω {σ}_{2} ( ω , T )}}$$

$$and {σ}_{2} = \frac{{σ}_{N} π Δ}{h} [ 1 - 2 {e}^{- Δ / {k}_{b} T} {e}^{- ℏω / 2 kT} {I}_{0} ( \frac{ℏω}{2 {k}_{b} T} ) ]$$

λ corresponds to magnetic penetration length.
d corresponds to the thickness of the track when it is a transmission line.
μ₀ corresponds to the permeability of vacuum.
σ₂ corresponds to the imaginary part of complex conductivity.
σ_{N} corresponds to conductivity in the normal state (non-superconducting).

The above formulas are valid for ℏω<2Δ; if this condition is not met, a person skilled in the art may refer to the Mattis-Bardeen integral formula.

Thus, having determined kinetic inductance using total inductance measurements, and knowing the characteristics of the constituent material of the passive component and its dimensions, it is possible to ascertain the temperature information.

The method according to the invention makes it possible to perform a measurement over a wide temperature range, which corresponds to the temperature range within which the passive component is in a superconducting state. The method according to the invention is thus suitable for any type of system that operates in the cold, that is to say up to a temperature of 15 K.

The computing steps may be carried out on a reprogrammable computing unit (a processor or a microcontroller for example) executing a program comprising a sequence of instructions, or on a dedicated computing machine (for example a set of logic gates such as an FPGA or an ASIC, or any other hardware module).

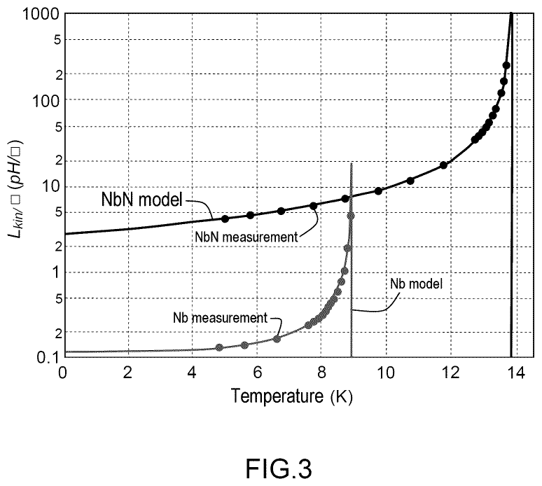

FIG. 3 illustrates one example of a curve showing kinetic inductance as a function of temperature, when the passive component is made of niobium nitride (NbN) or made of niobium (Nb). The dots represent values of the S parameter measured with a vector network analyzer, and the solid line represents the model. The critical temperature of niobium is equal to around 9 K, and that of niobium nitride is equal to around 14 K. The method thus makes it possible to choose the material of the passive component depending on the desired temperature range. The passive component must remain in a superconducting state over the entire measured temperature range.

Preferably, the material chosen for the passive component is such that the temperature range to be measured lies between what is referred to as a sensitivity temperature and the critical temperature of the material. The sensitivity temperature is lower than the critical temperature. Indeed, kinetic inductance is virtually constant between 0 K and around half the critical temperature. The sensitivity of the temperature measurement is thus optimal between αT_{c}, and T_{c}, with 0.5≤α≤0.8.

The method according to the invention advantageously makes it possible to have a wide temperature range, by using various materials and/or passive components made of the same material but with different geometric dimensions. For example, the monolayer or multilayer assembly may comprise a passive component made of niobium and a passive component made of niobium nitride, thereby making it possible to perform measurements between 3 and 14 K (between 3 and 9 K using the passive component made of niobium and between 5 and 14 K using the passive component made of niobium nitride).

Other superconducting materials may be envisaged, for example niobium titanium nitride (NbTiN, temperature range 3-12 K), titanium nitride (TIN, temperature range 2-5 K), or even granular copper aluminium alloy (AlCu, temperature range 1-2 K). These materials have the advantage of having a high kinetic inductance, thereby making it all the easier to determine the value of the kinetic inductance. Other materials may be suitable for implementing the invention.

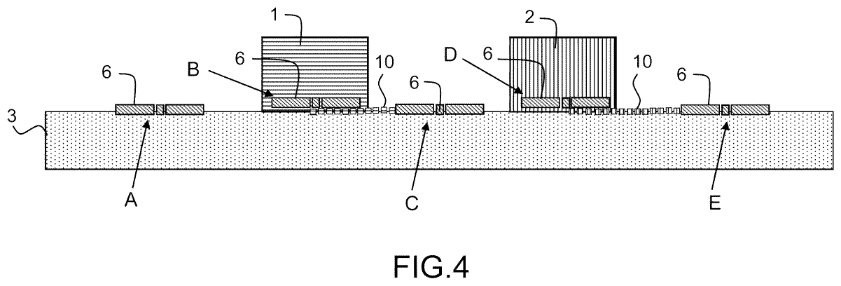

FIG. 4 illustrates examples of integrating passive components into a monolayer or multilayer assembly, in a sectional view. The passive component 6 may be integrated onto the interposer 3 without being connected to the quantum chip 1 or to the control chip 2 (configuration A). As a variant, the passive component 6 may be integrated in the last metallization layers (BEOL) of the quantum chip 1 (configuration B) or in the last metallization layers (BEOL) of the control chip 2 (configuration D). According to other variants, the passive component 6 may be integrated onto the interposer 3, and connected to the quantum chip 1 (configuration C), or connected to the control chip 2 (configuration E), by way of conductive tracks 10. According to another embodiment, the passive component may be integrated at the last metallization layers of the quantum chip 1, without an interposer.

The configuration depends essentially on the subject of the measurement. For example, if the temperature measurement is to be performed on the quantum chip, it is preferable to adopt one of configurations B or C.

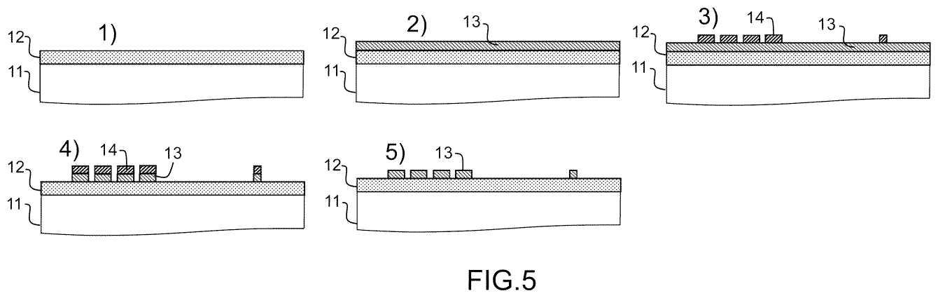

FIG. 5 illustrates examples of steps of integrating the passive component with a single metallization layer. This integration method is particularly suitable when the passive component is a transmission line.

A silicon substrate (wafer) 10 is oxidized over a certain thickness, by raising the temperature, in an oven, so as to form a silicon dioxide layer 12 (step 1). The first metallization layer 13 is deposited on the silicon dioxide layer 12 using one of the following processes: physical vapor deposition (PVD), chemical vapor deposition (CVD), plasma-enhanced chemical vapor deposition (PECVD), without this list being exhaustive (step 2). Photolithography is used to deposit a resin 14 in order to protect the metallization layer 13 at the desired locations (step 3). The unprotected metallization layer is etched by plasma-enhanced dry etching (step 4). The resin 14 is then removed (step 5).

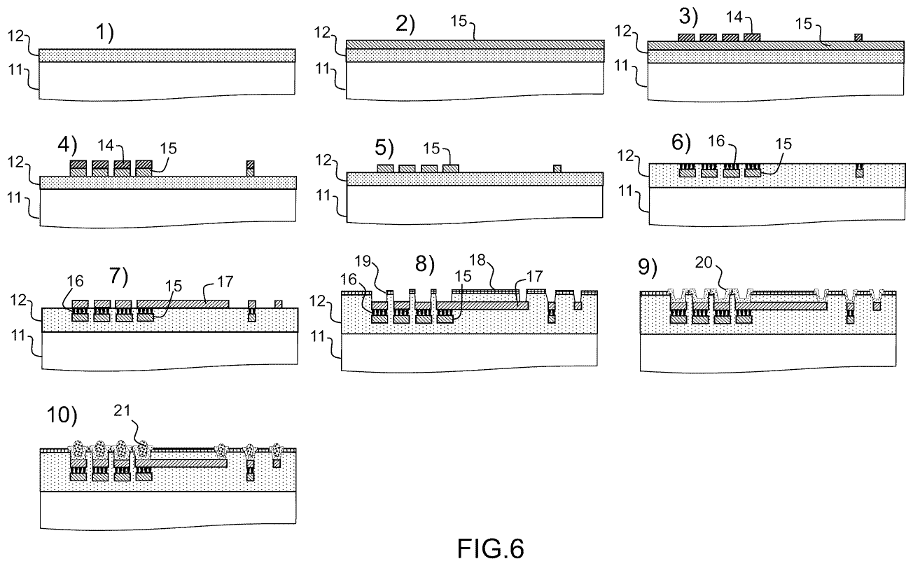

FIG. 6 illustrates examples of integrating the passive component with two metallization layers. This integration method is particularly suitable when the passive component is a coil (which may be integrated onto more than two metallization layers, for example onto four metallization layers).

The first five steps 1)-5) are identical to the case of integrating the passive component with a single metallization layer. At the end of step 5), the first metallization layer 15 is deposited. In the next step (step 6), a Damascene interconnect level is added (by chemical-mechanical polishing) in order to create vias 16 (for example made of titanium, titanium nitride or tungsten). The fabrication of the second metallization layer 17 is identical to the first five steps, that is to say plasma vapor deposition, photolithography, plasma-enhanced dry etching, resin removal. A protective silicon nitride layer 18 is added by passivation, and openings 19 are created at the locations reserved for the contact pads, thereby removing the passivation layer (step 8). An under bump metallization (or UBM) and gold plating layer 20 is added, and is intended to be interposed between the multilayer structure and the indium solder pads 21, which are intended to make contact with the quantum chip or with the control chip (steps 9 and 10).

The integration of the passive components is not limited to the above embodiments.

The passive component is thus integrated completely into the interposer (the integration would be similar at the last metallization layers of one of the chips), thereby simplifying the fabrication process. In addition, it may be integrated onto small systems or into systems that are difficult to access. The measurement is performed as close as possible to the points of interest (control chip, quantum chip).

The passive component is easy to manufacture because it has micrometric dimensions and a simple shape. The dimensions are constrained by technology; it would even be possible to use nanometric dimensions, which would make it possible to improve the integration of the sensor. Moreover, this would have a beneficial effect on measurement quality, because the passive component has no resistance, and kinetic inductance (on which the temperature measurement relies) increases with the fineness of the track.

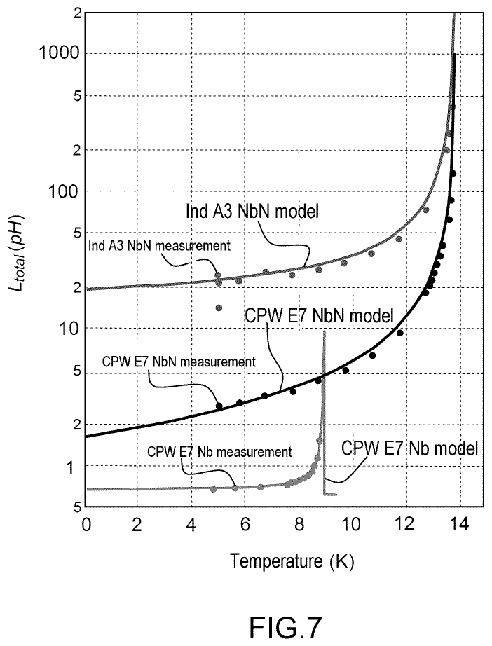

FIG. 7 illustrates various determinations of total inductance as a function of temperature, for three different passive components (CPW E7 Nb, CPW E7 NbN and Ind A3 NbN). This figure illustrates that total inductance and its range of variation (inductance sensitivity and temperature sensitivity) may be adjusted by the geometry of the component and the choice of material.

Other materials may be envisaged for the passive component 6 from type-I superconducting materials (for example Al, granular AlCu, TiN, In, W) or type-II superconducting materials (for example Nb, NbN, NbTi, NbTiN, Nb3Sn).

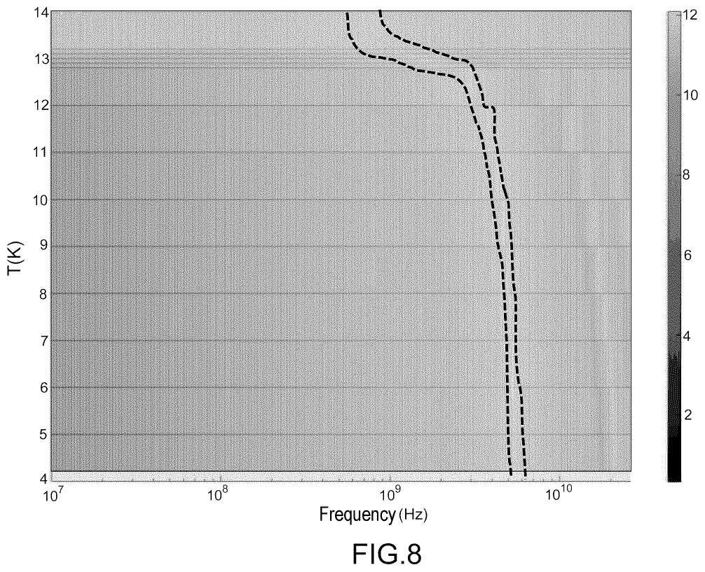

FIG. 8 illustrates the determination of temperature as a function of frequency, based on S parameters. This figure illustrates that the resonant frequency (maximum impedance in this case, cf. maximum between the dotted lines) varies with temperature.

Being able to accurately measure temperature as close as possible to the chips makes it possible to implement efficient temperature monitoring and control in a cryostat, comprising:
determining a setpoint temperature of the cryostat;
measuring the temperature in accordance with the above temperature measurement method;
regulating the temperature if the measured temperature is different from the setpoint temperature (that is to say if the measured value deviates from the setpoint value by a certain threshold).

### REFERENCES CITED

[1] “Superconducting routing platform for large-scale integration of quantum technologies” (Thomas et al., 2022 Mater. Quantum. Technol. 2, 035001)
[2] “Simple Accurate Expressions for Planar Spiral Inductances”, Sunderarajan S. Mohan et al., IEEE Journal of Solid-State Circuits, vol. 34, no. 10, October 1999
[3] “Multiport conversions between S, Z, Y, h, ABCD, and T parameters”, T. Reveyrand
[4] “Introduction to Superconductivity”, Michael Tinkham
[5] “Photon-detecting superconducting resonators”, Rami Barends

1. A method for determining temperature in the environment of an assembly comprising at least one passive component, the passive component being integrated into a monolayer or multilayer assembly, comprising the following steps:
determining the geometric inductance of the passive component, based on the dimensions of the passive component;
measuring the inductance of the passive component, referred to as total inductance, the passive component being used in a temperature range such that it is in a superconducting state;
determining the kinetic inductance of the passive component, based on the total inductance and the geometric inductance; and
determining the temperature based on the kinetic inductance of the component.

2. The method as claimed in claim 1, wherein the total inductance is measured by measuring S parameters on at least one of the ports of the passive component.

3. The method as claimed in claim 1, wherein the total inductance is measured by measuring impedance at the terminals of the passive component.

4. The method as claimed in claim 1, one of the preceding claims, wherein the passive component comprises a type-I superconducting material selected from a group comprising Al, granular AlCu, TiN, In, W, or a type-II superconducting material selected from a group comprising Nb, NbN, NbTi, NbTiN, Nb3Sn.

5. The method as claimed in claim 1, wherein the passive component is a transmission line, the transmission line being integrated onto one metallization level.

6. The method as claimed in claim 1, wherein the passive component is a coil, the coil being integrated onto at least two metallization levels.

7. The method as claimed in claim 1, wherein the passive component is integrated into the same substrate as a quantum chip or a control chip for controlling the quantum chip, so as to determine the temperature of the chip.

8. The method as claimed in claim 1, wherein the assembly comprises a plurality of passive components, the passive components being made of different materials, the materials being determined depending on the temperature range to be determined.

9. The method as claimed in claim 1, wherein the assembly comprises a plurality of passive components, the passive components having different dimensions, the dimensions being determined depending on the temperature range to be determined and on the targeted sensitivity.

10. The method as claimed in claim 1, wherein the temperature range lies between what is referred to as a sensitivity temperature and the critical temperature of the material, the critical temperature corresponding to the temperature below which the material is in a superconducting state, the sensitivity temperature being lower than the critical temperature.

11. The method as claimed in claim 10, wherein Tₛ=αT_{c}, T_{c} corresponding to the critical temperature, Tₛ corresponding to the sensitivity temperature, and 0.5≤α≤0.8.

12. A method for controlling temperature in a cryostat, comprising:
determining a setpoint temperature of the cryostat;
measuring the temperature in accordance with the method as claimed in claim 1; and
regulating the temperature if the measured temperature is different from the setpoint temperature.

13. A system for determining temperature in the environment of an assembly comprising at least one passive component, the passive component being integrated into a monolayer or multilayer assembly, the system comprising:
a computing unit, configured to determine the geometric inductance of the passive component, based on the dimensions of the passive component;
a system for measuring the inductance of the passive component, referred to as total inductance, the passive component being used in a temperature range such that it is in a superconducting state;
the computing unit furthermore being configured to
determine the kinetic inductance of the passive component, based on the total inductance and the geometric inductance;
determine the temperature based on the kinetic inductance of the component.

14. A cryostat comprising a system for determining temperature as claimed in claim 13.
